(19) United States
(12) Patent Application Publication
(10) Pub. No.: US 2019/0205482 A1
(43) Pub. Date: Jul. 4, 2019

(54) Computer Aided Design Model Conversion

(71) Applicant: Luther Walke, Huntsville, AL (US)

(72) Inventor: Luther Walke, Huntsville, AL (US)

(21) Appl. No.: 15/859,061

(22) Filed: Dec. 29, 2017

(51) Int. Cl. G06F 17/50

(52) U.S. Cl. CPC G06F 17/50; G06F 2217/74; G06F 2217/04; G06F 2217/02

(57) ABSTRACT

Techniques which may allow computer-aided design (CAD) conversion are described. In one implementation, CAD conversion may convert all objects placed in a 3D CAD model via a customized symbol into an object independent of that symbol, or in the case of parametric symbols, the user-defined form utilized for its placement. CAD conversion may also remove all constructions associated with the utilization of that symbol from any databases or files associated with the 3D CAD model.

### FIELD

This disclosure relates to computer-aided design model conversion.

### BACKGROUND

Automated computer-aided design (CAD) applications are often used by engineer, procure, or construct (EPC) companies to design large facilities. Automated CAD applications enable a user to automatically place complex components, for example, electrical, mechanical, architectural, civil, or structural objects, into a CAD model by using customized or parametric symbols. The EPC company often creates source code or user-defined forms for the symbols.

Clients of the EPC, for example, owner-operators, often demand a final “as-built” copy of the CAD model upon final handover of a facility for which the model was created. Because of their significant investment in their development and potential proprietary value, EPC companies are often reluctant to hand over compiled components for the customized symbols, associated user-defined forms, or source code of either. Moreover, the CAD model may be too complex to be useful for the owner-operator, who may be primarily concerned with facility operation and maintenance. Unfortunately, without the components containing compiled code, for example, a dynamic-link library (DLL), the model becomes effectively unusable for entities such as the owner-operator, who is unable to change objects that are reliant on the source code.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, techniques for computer aided design (CAD) model conversion. CAD model conversion may provide a mechanism for processing an automated CAD model in preparation for its handover to another entity, such as an owner-operator, upon completion of a project. In one implementation, all objects in a CAD model which had been placed using a customized symbol may be converted into an object independent of that symbol or, in the case of parametric symbols, the user-defined form utilized for its placement. All constructions associated with the utilization of that symbol may also be removed from databases or files associated with the CAD model. This processing of the model may be done in such a way that it may be handed over in a state well-suited for another entity's utilization of the facility for which the model was created. For example, the owner-operator may be provided a three dimensional (3D) virtual model which is useful for its effective operations, maintenance, or modernization of the facility.

### BRIEF DESCRIPTION OF THE DRAWINGS

The present description may be better understood from the following detailed description read in light of the appended drawings, wherein:

FIG. 1 is a flow diagram illustrating an example of a Computer Aided Design Model Conversion process.

FIG. 2 is a block diagram illustrating an example of a Computer Aided Design Model Conversion process.

FIG. 3 is a block diagram illustrating an example of a system capable of supporting a Computer Aided Design Model Conversion process.

FIG. 4 is a component diagram of a computing device which may support a Computer Aided Design Model Conversion process.

### DETAILED DESCRIPTION

A more particular description of certain implementations of Computer Aided Design Model Conversion may be had by references to the implementations shown in the drawings that form a part of this specification, in which like numerals represent like objects.

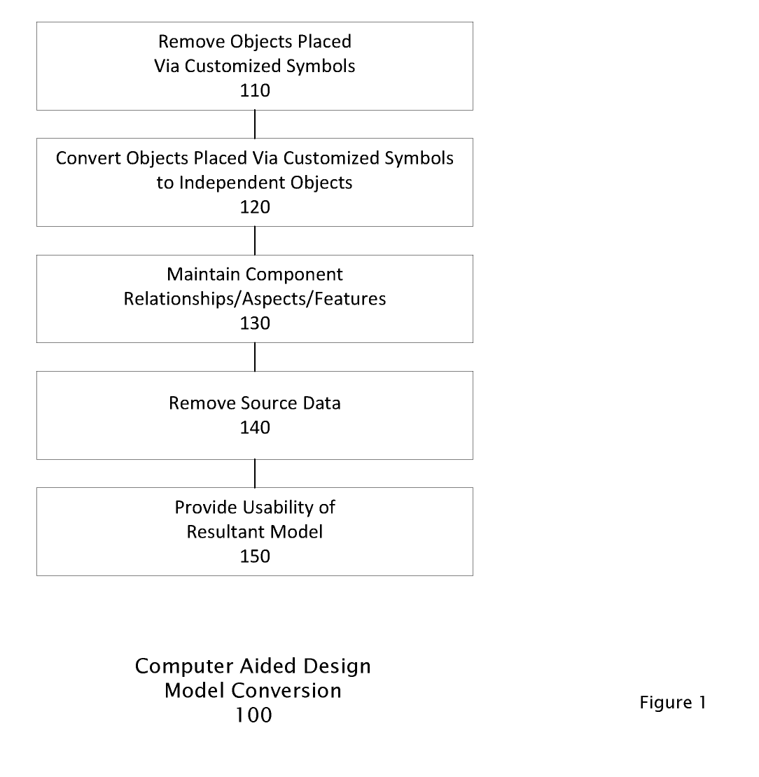

FIG. 1 is a flow diagram illustrating an example of a process for Computer Aided Design (CAD) Model Conversion 100. At Remove Objects Placed Via Customized Symbols 110, CAD Model Conversion 100 may remove any or all occurrences of objects which had been placed in a CAD model via a customized or parametric symbol. A customized symbol may comprise a visual representation created by an entity performing the design with or without an accompanying source code or user-defined form, which may or may not accept entry of parameters, thereby making it a parametric symbol. A parametric symbol may allow a user to input various parameters (for example, length, width, or number of nozzles), or reads them from surrounding objects and then automatically creates a custom object (for example, an equipment vessel, pipe support, or instrument) meeting a size, shape, or other physical or data attributes demanded by its appropriate design.

CAD Model Conversion 100 may remove any or all electrical, mechanical, including, for example, piping, heating, ventilation, and air conditioning (HVAC), and instrumentation, architectural, civil, structural, or other components, for example, equipment, supports, piping, specialty items, or operate to failure (OTF) instruments from the CAD model which had been placed by a customized or parametric symbol. An entity performing the design, such as an engineer, procure, or construct (EPC) company, may have created source code for placement of the object via a customized symbol, or it may have created user-defined forms utilized for placement of the object via a parametric symbol. The entity may have stored the compiled code or user-defined forms in a database, for example, a DLL. The entity may consider the source code or user-defined form to be proprietary intellectual property or may be otherwise reluctant to hand over compiled components associated with the symbols to another entity, for example, an owner-operator of a facility for which the CAD model was created.

At Convert Objects Placed Via Customized Symbols to Independent Objects 120, CAD Model Conversion 100 may replace a removed object with an object which may comprise a near or exact replica of that object, but one that has been modeled without the benefit of a customized symbol, a parametric logic contained within that symbol, or any user-defined form required to place the object via that symbol. A resultant processed object may appear to an observer of the CAD model as if it were manually created using generic or primitive shapes or basic parts, for example, basic steel members. The resultant processed object may be independent of and no longer reliant on source code or user-defined forms associated with customized or parametric symbols. The objects may be removed from the CAD model without affecting usability of the model by another entity, such as an owner-operator, for operations, maintenance, additions, or modernization of a facility.

At Maintain Relationships/Aspects/Features 130, CAD Model Conversion 100 may maintain all relationships between the processed object and other objects in the CAD model. For example, a connection of a pipe run to a nozzle belonging to a processed piece of equipment may be maintained. All graphical aspects of an object which had been placed by a customized or parametric symbol may be nearly or exactly replicated on a resultant processed object, including that of basic graphics representing the item, centerlines belonging to the item or its subcomponents, additional graphical details added to the item's representation, or any customized graphical aspects automatically created by an owner of the customized or parametric symbol.

For example, in addition to base graphics, CAD Model Conversion 100 may replicate graphical aspects such as insulation aspects, maintenance volumes, or custom aspects. All nozzles may be transferred from and associated with the newly designed equipment, and intelligent connections between nozzles and piping may also be maintained, for example. Regarding support objects, connectivity between supports and supporting steel members, concrete slabs, or equipment objects may be maintained, provided such a relationship exists. Regarding piping objects, port connections may be maintained along with all data associated with those ports. Geometric precision, notes, and attributes may be maintained. Relationships between nozzles to equipment, parent-child relationships, and ports including welds, bolts and nuts, gaskets, or clamps, may also be maintained. Moreover, all properties may be transferred from the original equipment to the new equipment. For example, nozzles properties may be maintained on transposed nozzles. Any attributes not designed may be marked such that they are not transferred during the purge process.

At Remove Source Data 140, once objects which had been placed by customized or parametric symbols have been removed and replaced, or at any other time, CAD Model Conversion 100 may process any catalog, reference files, or databases to expunge any traces that a user-defined, customized symbol, or any constructs required to support it, ever existed. For example, CAD Model Conversion 100 may remove corresponding definitions from a catalog, corresponding symbol DLLs from a symbol share, or any other data from data sources.

In one implementation, CAD Model Conversion 100 may convert objects which had been set to a naming rule to “User Defined,” and an associated text string may be maintained as if manually entered, via an application programming interface (API) from an external source, or entered directly into an associated database. An API may use a Component Object Model (COM) interface, for example. Once CAD Model Conversion 100 converts all attributes, it may expunge the naming rule from an associated database at Remove Source Data 140.

In another implementation, non-essential interfaces may be identified to a user, and the user may have an option to retain the associated information or not.

In one implementation, the initial object removal process may automatically record all symbol definitions selected by a user for processing such that a secondary, post-process may self-instantiate.

At Provide Usability of Resultant Model 150, once processed, a resultant object may maintain an ability to be modified, copied, or assigned relationships to systems within the model. All notes or pertinent interfaces, attributes, or values for those attributes may be maintained and available to another entity for purposes of viewing, reporting upon, retrieving from a database, or modifying where appropriate.

CAD Model Conversion 100 may provide an owner-operator with a functional 2D or 3D model which protects the designer's, for example, an EPC company's potential intellectual property interests. The resultant model may provide an owner-operator with usability capabilities for effective operation, maintenance, additions, or modernization of its facility. Capabilities may be fully supported for engineering disciplines including electrical, mechanical, architectural, civil, or structural, for example. Capabilities may include full modification capabilities including but not limited to the following: move, rotate and delete; insert functions; support for all native hierarchies; system; assembly; work breakdown structure (WBS); space volume; replication such as copy and paste, mirror, or memory data register (MDR); native report generation; native drawing generation such as ortho/isometric; native support for custom attributes; support for API customization; R3D output and input; or SPR VUE generation.

A resultant processed model may also be fully suited to support all requirements associated with brownfield, or work-order, projects executed by an owner-operator. Capabilities supported may include that a model remains fully specification-driven, upgradeable to newer versions of software, supportive of all native modification capabilities, maintenance of native connectivity to pipe, component, or equipment nozzles, for example, or full 2D or 3D reference capabilities, for example, R3D, Laserscan, or uStation 2D/3D.

In one implementation, CAD Model Conversion 100 may provide an owner-operator with a “lightweight” model to easily generate graphical interpretations of the original model either as stills or animations, for example. The process may be selective, providing a hybrid situation wherein some parametric symbols may be handed back over with a model, while others are not.

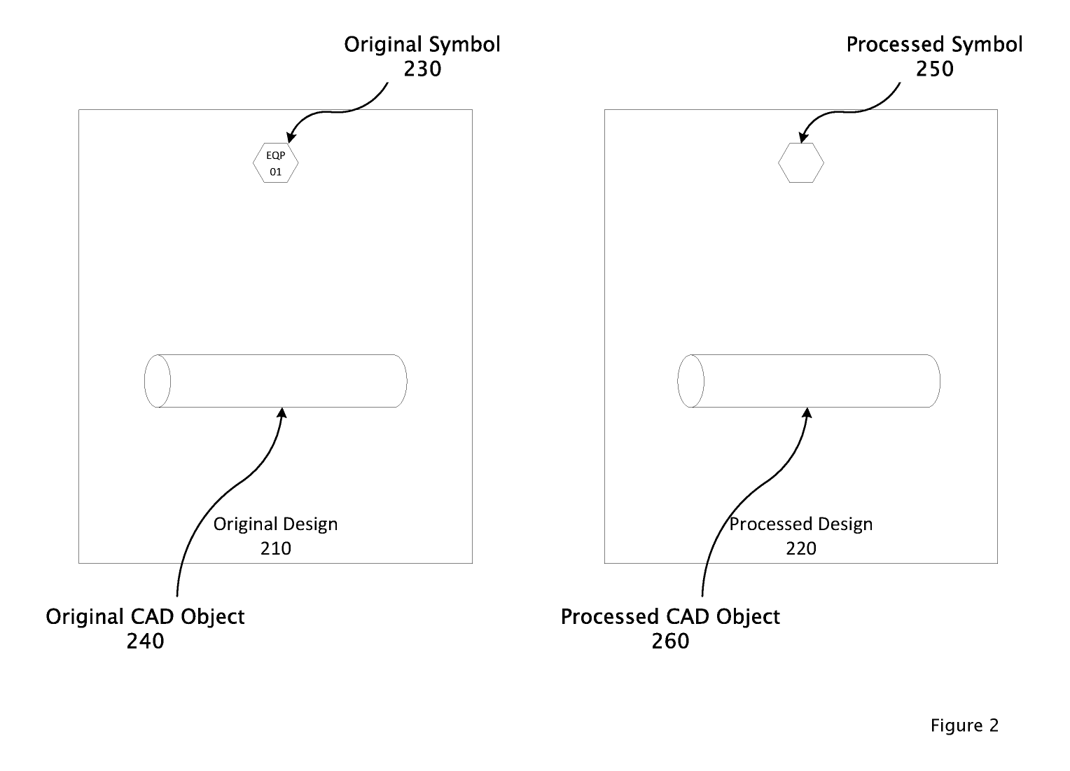

FIG. 2 is a block diagram illustrating an example of a process for Computer Aided Design (CAD) Model Conversion. Original Design 210 may comprise an automated 2D or 3D CAD model including occurrences of objects, for example, Original CAD Object 240, which had been placed in the model via customized symbols or parametric symbols, for example, Original Symbol 230. Processed Design 220 may comprise the CAD model after undergoing the CAD Model Conversion process. In Processed Design 220, what had been Original CAD Object 240 in Original Design 210 may be replaced with Processed CAD Object 260, which may comprise a near or exactly replica of CAD Object 240 which is independent of the customized or parametric symbol used for its placement. Original Symbol 230 may also be processed into a generic or primitive shape, such as Processed Symbol 250, or it may be completely removed from Processed Design 220, and data sources indicating its existence may also be removed. CAD Model Conversion may maintain relationships, aspects, or features of Original CAD Object 240, for example, equipment, supports, piping components, or instruments and specialty items, in the resultant Processed CAD Object 260 or Processed Design 220.

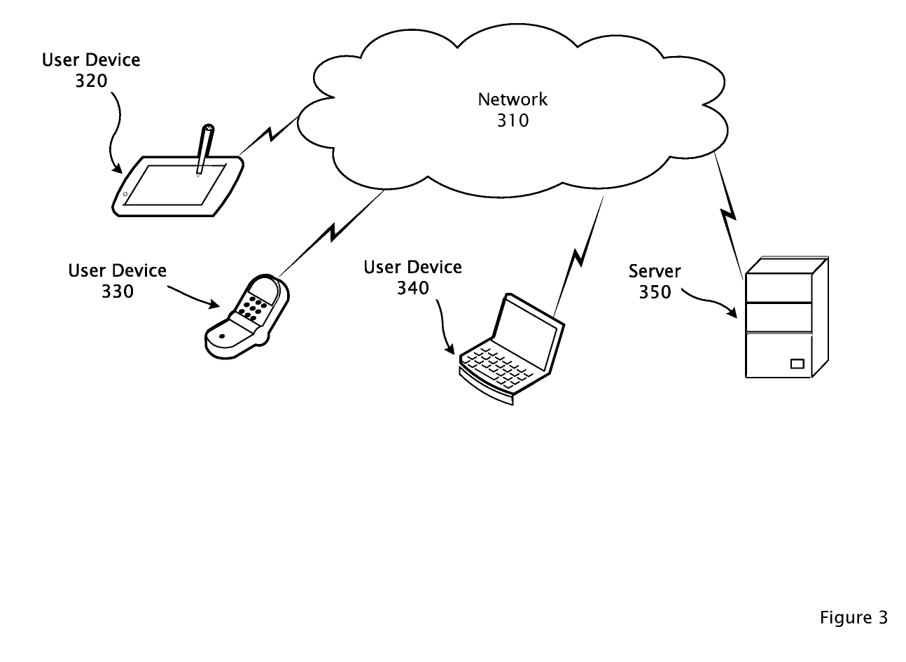

FIG. 3 is a block diagram illustrating an example of a system capable of supporting Computer Aided Design Conversion, according to one embodiment.

Network 310 may include Wi-Fi, cellular data access methods, such as 3G or 4GLTE, Bluetooth, Near Field Communications (NFC), the internet, local area networks, wide area networks, or any combination of these or other means of providing data transfer capabilities. In one implementation, Network 310 may comprise Ethernet connectivity. In another implementation, Network 310 may comprise fiber optic connections.

User Device 320, 330, or 340 may have network capabilities to communicate with Server 350. Server 350 may include one or more computers, and may serve a number of roles. Server 350 may be conventionally constructed, or may be of a special purpose design for processing data obtained from Computer-Aided Design Conversion. One skilled in the art will recognize that Server 350 may be of many different designs and may have different capabilities.

User Device 320, 330, or 340 may be used by engineers reviewing designs, for example, by accessing a website or executing an app. Server 350 may store a design, and may be used to host a website, allow editing of the design, or perform other tasks. One having skill in the art will recognize that various configurations for User Device 320, 330, or 340 and Server 350 may be used to implement Computer-Aided Design Conversion.

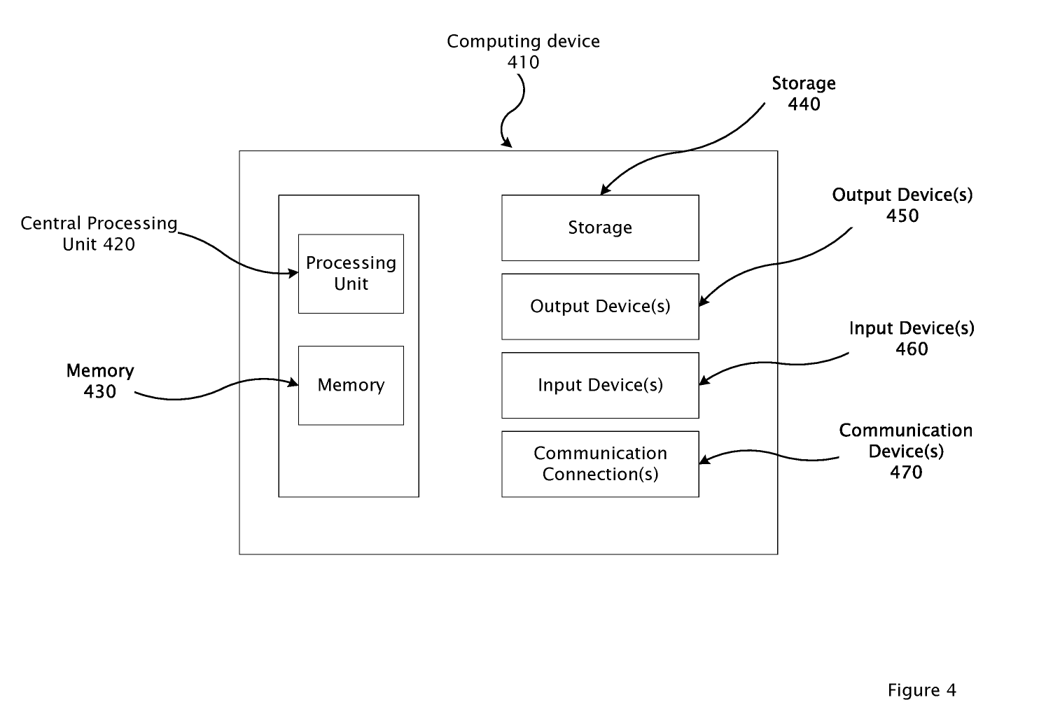

FIG. 4 is a component diagram of a computing device which may support Computer Aided Design Conversion, according to one embodiment.

Computing Device 410 can be utilized to implement one or more computing devices, computer processes, or software modules described herein, including, for example, but not limited to a mobile device. In one example, Computing Device 410 can be used to process calculations, execute instructions, and receive and transmit digital signals. Computing Device 410 can be any general or special purpose computer now known or to become known capable of performing the steps or performing the functions described herein, either in software, hardware, firmware, or a combination thereof.

In its most basic configuration, Computing Device 410 typically includes at least one Central Processing Unit (CPU) 420 and Memory 430. Depending on the exact configuration and type of Computing Device 410, Memory 430 may be volatile (such as RAM), non-volatile (such as ROM, flash memory, etc.) or some combination of the two. Additionally, Computing Device 410 may also have additional features/functionality. For example, Computing Device 410 may include multiple CPU's. The described methods may be executed in any manner by any processing unit in Computing Device 410. For example, the described process may be executed by both multiple CPUs in parallel.

Computing Device 410 may also include additional storage (removable or non-removable) including, but not limited to, magnetic or optical disks or tape. Such additional storage is illustrated by Storage 440. Computer-readable storage media includes volatile and nonvolatile, removable and non-removable media implemented in any method or technology for storage of information such as computer-readable instructions, data structures, program modules or other data. Memory 430 and Storage 440 are all examples of computer-readable storage media. Computer-readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by Computing Device 410. Any such computer-readable storage media may be part of Computing Device 410. But computer-readable storage media does not include transient signals.

Computing Device 410 may also contain Communications Device(s) 470 that allow the device to communicate with other devices. Communications Device(s) 470 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer-readable storage media and communication media. The described methods may be encoded in any computer-readable media in any form, such as data, computer-executable instructions, and the like.

Computing Device 410 may also have Input Device(s) 460 such as a keyboard, mouse, pen, voice input device, touch input device, etc. Output Device(s) 450 such as a display, speakers, printer, etc. may also be included. All these devices are well-known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described implementations may be made without departing from the spirit and scope of the invention.

Additionally, the illustrated operations in the description show certain events occurring in a certain order. In alternative implementations, certain operations may be performed in a different order, modified or removed. Moreover, steps may be added to the above-described logic and still conform to the described implementations. Further, operations described herein may occur sequentially, or certain operations may be processed in parallel. Yet further operations may be performed by a single processing unit or by distributed processing units.

1. A method, comprising:
removing occurrences of a first object from a computer aided design model, wherein the first object had been placed in the computer aided design model using a customized symbol;
converting the first object into a second object independent of the customized symbol; and
removing constructs associated with the customized symbol from a data source associated with the computer aided design model, giving a processed model.

2. The method of claim 1, the second object independent of source code utilized for placement of the first object.

3. The method of claim 1, wherein the customized symbol comprises a parametric symbol.

4. The method of claim 1, enabling modification of the processed model from the list consisting of move, rotate, copy, paste, modification of read or write attributes, delete, assignment to a parent object in hierarchy, assignment to a parent object in a plant breakdown structure, and assignment to a parent object in work breakdown structure.

5. The method of claim 1, wherein constructs associated with the customized symbol removed from a data source associated with the computer aided design model are constructs from the list consisting of:
a dynamic-link library component containing compiled code for the customized symbol,
extensible markup language (XML) file or other mechanisms for referring to the symbol's dynamic-link library component,
references to or supporting information of the customized symbol in catalog or reference data repositories, and
any caches of information of an original occurrence object in a model database.

6. The method of claim 1, further comprising automatically recording symbol definitions selected by a user for processing such that a secondary post-process can self-instantiate.

7. The method of claim 1, wherein engineering disciplines capable of being processed include those from the list containing electrical, mechanical, architectural, civil, and structural.

8. The method of claim 1, wherein relationships, aspects, or features associated with the first object are maintained.

9. The method of claim 1, wherein non-essential interfaces are identified to a user, and the user is allowed an option for not retaining that information.

10. The method of claim 1, wherein a user populating the computer aided design model is provided with a mechanism for selecting which objects existing in the model will be processed or those which will not be processed.

11. The method of claim 10, further comprising assisting the user populating the computer aided design model in identifying which components are candidates for processing.

12. The method of claim 1, wherein all COM interfaces and associated attributes of the first object are transferred to the second object.

13. The method of claim 12, wherein the second object is independent of a user-defined form utilized for placement of the first object.
